(19) United States
(12) Patent Application Publication
(10) Pub. No.: US 2011/0016955 A1
(43) Pub. Date: Jan. 27, 2011

(54) Sample Dilution for Chromatography of Multiple Process Streams

(75) Inventor: Sylvain Cormier, Mendon, MA (US)

Correspondence Address: Waters Technologies Corporation, 34 MAPLE STREET - LG, MILFORD, MA, 01757, US

(73) Assignee: WATERS TECHNOLOGIES CORPORATION, Milford, MA (US)

(21) Appl. No.: 12/919,555

(22) PCT Filed: Feb. 25, 2009
(86) PCT No.: PCT/US2009/035049

§ 371 Date: Oct. 12, 2010

Related U.S. Application Data
(60) Provisional application No. 61/032,687, filed on Feb. 29, 2008.

(51) Int. Cl. G01N 30/16; G01N 35/10

(52) U.S. Cl. 73/61.55; 73/864.34

(57) ABSTRACT

A method of liquid chromatography includes providing an injection valve, drawing a sample and a diluent while mixing, pushing the mixed sample and diluent onto a sample loop of the injection valve, and injecting the mixed sample and diluent. An analytical apparatus includes a proportioning unit, an injection valve having a sample loop, and a sample pump. The injection valve has a draw state and a load state, and has a port in fluidic communication with an outlet port of the proportioning unit. The sample pump is in fluidic communication with the outlet port of the proportioning unit, if the injection valve is in the draw state, to draw both a sample and a diluent through the proportioning unit and the injection valve, and in fluidic communication with the sample loop, if the injection valve is in the load state, to push the drawn sample and diluent onto the sample loop.

### RELATED APPLICATIONS

The application claims priority to U.S. Provisional Patent Application No. 61/032,687, filed Feb. 29, 2008, the entire contents of which are incorporated herein by reference.

### TECHNICAL FIELD

The invention relates to chromatographic apparatus and methods, and, in particular, to apparatus and methods for dilution and mixing of chromatographic samples.

### BACKGROUND OF THE INVENTION

Liquid chromatography (LC) involves a separation process, which is utilized, for example, for chemical analysis or preparation. A typical LC system includes a mobile-phase pump, a sample injector, a column, and a detector. The column typically contains a stationary inert porous material, often composed of particles. The pump propels a mobile-phase fluid along a fluidic path that passes through the injector, column, and detector. The injector introduces a sample into the mobile-phase fluid prior to entry of the fluid into the column.

Typically, mobile-phase solvents are stored in reservoirs, and delivered as required via reciprocating-cylinder based pumps. Sample materials are often injected via syringe-type pumps. For example, some LC systems inject a sample by aspirating (pulling) a fluid-based sample into a tube via a needle or capillary and then pushing the sample into a sample loop. The sample is then injected from the sample loop into the mobile-phase stream on its way to a separation column.

Distinct chemical compounds contained in the fluid often have distinct affinities for the stationary material held in the column. Consequently, as the fluid moves through the chromatographic column, various chemical compounds are delayed in their transit through the column by varying amounts of time in response to their interaction with the stationary porous material in the column. As a result, as the compounds are carried through the medium, the compounds separate and elute from the column over different periods of time.

The different chemical compounds in a sample solution typically separate out as individual concentration peaks in the fluid eluting from the column. The various separated chemicals can be detected by, for example, a refractometer, an absorbtometer, or some other detecting device into which the fluid flows upon leaving the chromatographic column, such as a mass spectrometer.

LC has potential as a tool in support of Process Analytical Technology (PAT). PAT entails apparatus and methods that are employed in support of pharmaceutical manufacturing. A typical PAT system supports analysis and control of manufacturing through timely measurements (i.e., during processing) of critical quality and performance attributes of raw and in-process materials and processes with the goal of ensuring final product quality. The word “analytical”, with respect to PAT tools, broadly relates to chemical, physical, microbiological, mathematical, and risk analysis conducted in an integrated manner.

In the PAT context, LC is used, for example, to determine when a desired reaction product, e.g., a drug, has begun to appear in a process stream, so that collection of the process stream may commence; LC is also used to determine when collection should cease. The effectiveness of LC analyses are limited, however, by the time delay between collection of a sample, and completion of analysis of the sample. This delay is related to the length of time required to collect a sample and the length of time required to analyze the sample. Typical LC equipment does not readily lend itself to PAT support, in part due to difficulty in interfacing the LC equipment to a compound-manufacturing process line.

The output flow of a pharmaceutical-manufacturing process, in some cases, is directed through plumbing that accommodates the time lag exhibited by analytical data. After detection of the appearance of the desired compound in the process stream, collection can commence from an appropriate location of the plumbing. Limits in sampling frequency and in speed of sample collection and analysis limit the accuracy in attempts to implement optimal collection of the desired portion of a process stream. Deviations from optimal collection are costly.

Moreover, a sample must often be diluted before injectioin into the mobile phase. For example, one may dilute a sample to reduce an injected sample load (e.g., picoliters) to avoid a mass overload condition for a particular chromatography column. Alternatively, a sample solution may contain a solvent that is incompatible with a column's stationary phase due to a physical property (e.g., pH level) of the solvent. Similarly, a sample solution may contain a strong solvent that interacts more efficiently with a column's stationary phase than does the sample material dissolved in the solution, leading to distortions in the separation of the sample material as it passes through the column.

A skilled technician can manually dilute a sample solution, however, manual dilution may be impractical and/or costly. In many instances, the technician and equipment for performing the dilution are located an inconvenient distance from the LC system. Significant delay can occur if the sample is transferred to a remote location for dilution, potentially resulting in manufacturing or processing downtime. Moreover, the additional inconvenience of tracking the transported sample is often necessary. In particular, such configuration and operation of an LC-based system does not lend itself to the speed and automation desirable for PAT-related manufacturing support.

### SUMMARY

The invention arises, in part, from the realization that an LC sample can be diluted during drawing of the sample from a sample source, using, for example, a single pump to draw and simultaneously mix both a sample and a diluent. A particular dilution ratio can be selected, for example, through use of a proportioning component, such as a proportioning valve, through which the sample and diluent are drawn.

Accordingly, in one aspect, the invention features a method of liquid chromatography. The method includes providing an injection valve, drawing a sample from a sample source, drawing a diluent from a diluent source, mixing—substantially while drawing—the sample and the diluent, pushing the mixed sample and diluent onto a sample loop of the injection valve, and injecting the mixed sample and diluent.

In another aspect, the invention features an analytical apparatus. The apparatus includes a proportioning unit, an injection valve having a sample loop, and a sample pump. The proportioning unit has a first inlet port, in fluidic communication with a sample source, a second inlet port, in fluidic communication with a diluent source, and an outlet port. The injection valve has a draw state and a load state, and has an inlet port in fluidic communication with the outlet port of the proportioning unit. The sample pump is in fluidic communication with the outlet port of the proportioning unit, if the injection valve is in the draw state, to draw both a sample from the sample source and a diluent from the diluent source through the proportioning unit and the injection valve, and in fluidic communication with the sample loop, if the injection valve is in the load state, to push the drawn sample and diluent onto the sample loop.

The apparatus and method support drug-manufacturing process monitoring and/or control through automated sample dilution, or other automated mixing-related processes.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of a PAT tool and associated process lines supported by the PAT tool, in accordance with one embodiment of the invention;

FIG. 2a is a schematic diagram of an analytical apparatus, in accordance with one embodiment of the invention; and

FIG. 2b is an enlarged diagram of the injection valve illustrated in FIG. 2a.

### DETAILED DESCRIPTION

The term “in-line” herein refers to sample analysis of a process stream that occurs with little or no diversion of the process stream. For example, an in-line analysis optionally is accomplished by disposing a detector and/or related components in the flow path of a process stream.

The term “on-line” herein refers to sample analysis of a process stream that entails diversion of a portion of the process stream substantially directly to a chemical analysis device.

The term “at-line” herein refers to sample analysis of a process stream than entails diversion and collection of a portion of the process stream prior to analysis of the collected portion. Collection occurs either external to a particular analysis tool or internal to the tool. Collected portions are, for example, collected in sample vials. The terms in-line, on-line and at line are terms of convenience, and are not intended to be rigid; therefore, it will be understood that some overlap in these definitions may exist.

The word “chromatography” and the like herein refer to equipment and/or methods used to perform separation of chemical compounds. Chromatographic equipment typically moves fluids under pressure and/or electrical forces. The acronym “HPLC” (high-pressure or high-performance LC) is used herein generally to refer to liquid chromatography performed at pressures of approximately 1,000 to 2,000 psi or greater. “UHPLC” (ultra high-pressure or ultra-high-performance LC) is used herein generally to refer to liquid chromatography performed at pressures of up to approximately 15,000 to 20,000 psi or greater.

The term “sample loop” is used herein to refer broadly to any suitable container, vessel, conduit, or tube that temporarily holds a sample portion prior to injection and separation, including, for example, sample loops that are known to one having ordinary skill in HPLC and UHPLC.

The word “line” is used herein to refer to any suitable conduit that carries fluids in a chromatography system. Depending on application, suitable conduits include those formed from stainless steel tubing and fused-silica capillary tubing.

The word “column” herein refers to a vessel, including, for example, one or more tubes, within which separation of compounds occurs.

Preferred embodiments of the invention entail methods and apparatus that interface UHPLC components to multiple sample sources. The methods and apparatus are suited, for example, to support of PAT initiatives for monitoring and/or control of drug-manufacturing processes. The embodiments described below support on-line and/or at-line analyses.

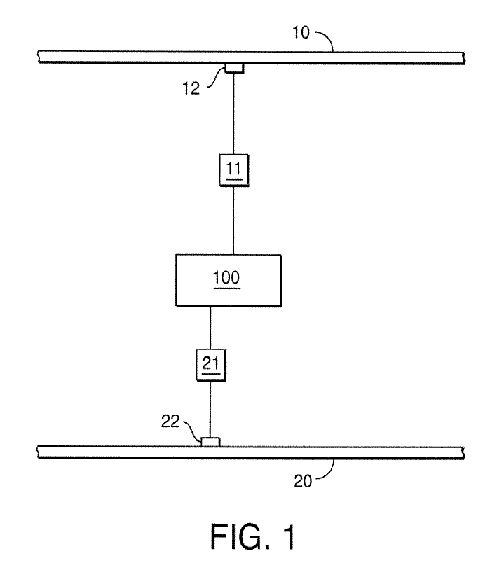

FIG. 1 is a block diagram of an analytical apparatus 100 for monitoring one or more process streams in pharmaceutical manufacturing (shown supporting two process streams); the diagram also illustrates portions of two process lines 10, 20 (e.g., composed of stainless-steel tubes.) The process lines 10, 20 have associated ports 12, 22 to support diversion of portions of the associated process streams. Each port 12, 22 is plumbed to a respective valve 11, 21. The valves 11, 21, in turn, support interfacing to the apparatus 100 via additional plumbing.

Plumbing, ports and valves, in various embodiments of the invention, are any suitable components, including components known to one of ordinary skill in the LC arts. One of ordinary skill will understand that it is generally desirable to minimize the quantity of diverted material and the flow-path distance from a process line to an analyzer portion of an apparatus.

The apparatus 100 is optionally configured for on-line and/or for at-line analyses. For at-line support, the apparatus 100 includes components that collect samples and components that transport the collected samples to an analyzer portion of the apparatus 100. The analyzer portion preferably provides relatively high-speed analyses in support of the rapid response desired in a typical pharmaceutical manufacturing setting. The apparatus 100 is optionally a modified version of an ACQUITY UPLC® chromatography apparatus (available from Waters Corporation, Milford, Mass.)

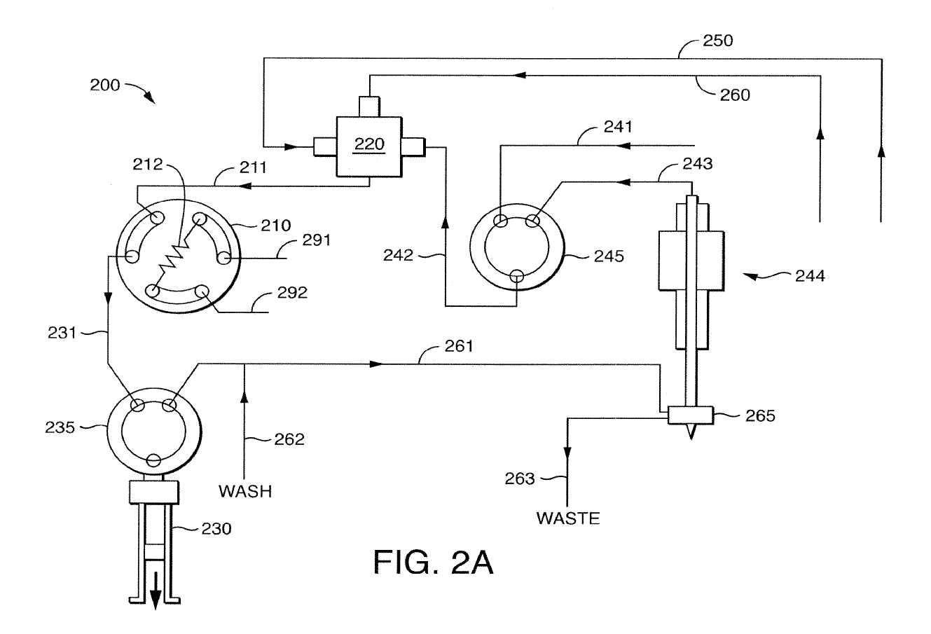

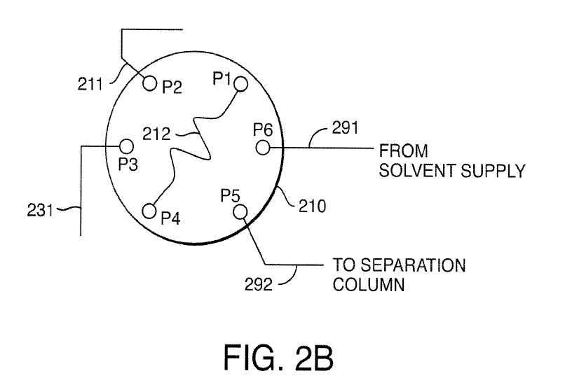

Next, an example of an apparatus and its operation are described in more detail. FIG. 2a is a schematic diagram of an analytical apparatus 200, in accordance with one embodiment of the invention. The apparatus 200 includes an injection valve 210 having a sample loop 212 and six ports P1-P6, two selection valves 235, 245, a pump 230, a proportioning valve 220, a sampling needle 242, a needle-wash component 265, a diluent source line 250, a reagent source line 260, a wash source line 262, a waste line 263, and various tubing lines 241, 242, 231, 211, 261, 291, 292 that support plumbing to fluidically connect the various components of the apparatus 200. FIG. 2b is a diagram of the injection valve 210, enlarged to illustrate the six ports P1-P6.

The selection valve 235 selectably connects the pump 230 to a port P3 of the injection valve 210, via line 231, or to a line 261 that supports washing of the sampling needle 244. The line 261 is connected to a wash-solution supply line 262 and to the needle-wash component 265; the component 265, in turn, is connected to a waste line 263.

For needle washing, the sampling need 242 is inserted in the needle-wash component 265, which includes a needle wash seal. The selection valve 235 connects the pump 230 to the line 261. The pump 230 draws a wash solution from the wash-solution supply line 262 and then pushes the wash solution into the needle 244 via the line 261 and the needle-wash component 265.

The sample supply line 242 is connected to the second selection valve 245, which permits selection of a desired source from which to draw a sample (i.e., from the sampling needle 244, via a line 243, or from a process line, via the line 241.) Some alternative embodiments do not include a sample selection valve. For example, an apparatus is optionally dedicated to on-line or at-line analysis.

For at-line analyses, as will be understood by one of ordinary skill in the LC arts, the apparatus is optionally configured to collect process samples in vials; samples are then extracted from the vials, via the sampling needle 244, for analyses.

The proportioning valve 220 has three inlet ports, each having an associated switching valve and connected, respectively, to the diluent supply line 250, the reagent supply line 260, and to the sample supply line 242. The outlet port of the proportioning valve 220 is connected, via line 211, to a port P2 of the injection valve 210. Alternative embodiments include proportion valves having more or fewer than three ports, or alternative proportioning components that serve to mix and/or mediate the flow of fluids along two or more supply lines.

The composition of fluid delivered to the output line 211 is determined by a timing sequence of the switching valves of the proportioning valve 220. Thus, for example, a sample/diluent mixture of a desired ratio is obtained by drawing on the outlet line 211, by the pump 230, while appropriately opening and closing the switching valves associated with the inlet ports connected to the diluent supply line 250 and the sample supply line 242. The proportions of sample and diluent in the mixture depend on the relative actuation time of the switches in relation to the fluid velocity profile provided by the pump 230. The rate of opening and closing is optionally increased to promote mixing.

FIG. 2a depicts the injection valve 210 in a draw state. In this state, the pump 230 is used to draw a desired sample mixture, as mediated by the proportioning valve 220, for subsequent loading onto the sample loop 212. During drawing, the mixture is disposed adjacent to one of the ports P2, P3 of the injection valve 210, respectively without or with being drawn through the injection valve 210.

For example, the mixture is drawn through the injection valve 210 until it resides entirely, or in part, in the line 231, adjacent to the port P3. The mixture is then pushed, by the pump 230, onto the sample loop 212, after switching the injection valve 210 to a load state, as will be understood by one having ordinary skill in the chromatographic arts. Then injection valve 210 is then switched to an inject state to inject the loaded mixture into a solvent stream carried by the lines 291, 292, for delivery to a separation column.

The apparatus 200 is thus configured to provide sample mixing at the time a sample is drawn. The injection valve 210 and the proportioning valve 220 cooperate to permit the sample pump 230 to substantially simultaneously draw two or more fluids to the injection valve 210 and to mix the fluids.

The sample pump 230 is selected from any suitable pumping devices, including known devices, such as a chromatographic metering syringe.

Preferably, reliance on pulling of a sample is minimized by, for example, optimized selection of tubing length and diameter. When pulling a sample, air pressure and tubing diameter are associated with a limit on flow rate; in effect, a vacuum pulls the sample, limited by ambient pressure, e.g., 14.7 psi. When pushing a sample, the pump 230 is able to apply much higher pressures, causing much higher flow rates.

As will be understood by one having ordinary skill in LC, the sample loop 212 receives the mixed sample for injection into an analysis stream for delivery to a separation column (not shown.) The tubes 291, 292 connect the process stream to the injection valve 210 via two ports P5, P6. One tube 292 carries a mobile phase, such as a solvent, to the injection valve 210; after injection of a sample from the loop 212 into the mobile phase, the mobile phase and sample are delivered to the separation column via the other tube 291. The injection valve 210 includes, for example, any multiport valve that is suitable for switchably connecting conduits in a chromatographic system.

The apparatus 200 is optionally implemented as a HPLC or UHPLC system. In these cases, the injection valve 210 is any suitable valve, including any suitable commercially available injection valve that supports sample loading and/or injection in a HPLC or UHPLC system. For example, the injection valve 210 is optionally a 6- or 10-port loop injection valve (available, for example, from Bio-Chem Valve/Omnifit, Booton, N.J.) In the illustrated example, the injection valve 210 is a six-port injection valve.

The sample loop 212 is any suitable sample-holding component, such as a sample loop known to one having ordinary skill in chromatography. For example, the sample loop 212 has any desired volume, for example, a fixed volume of 2, 5, 10, or 20 μl, or more, such as 250 μl.

As noted above, a sample is optionally diluted to reduce mass loading or to provide a compatible sample mixture composition. Dilution is also optionally used to permit analyses over a wider range of concentrations.

A reagent is optionally added, with or without a diluent, as desired for one or more of a variety of purposes. A reagent is added, for example, to a blank sample to create an external standard for calibration, or is added to an unknown sample for quantitation by internal standards or standard additions. Alternatively, for example, a reagent is added to modify a sample to allow separation or detection, to stop or start a reaction, or to denature a protein so that it exhibits suitable affinity for a column separation material.

Thus, the diluent line 250 and the reagent line 260 are each provide access to one or more diluent(s) and reagent(s) sources, which contain any solutions, as desired, to support analysis of manufacturing processes and apparatus monitoring. For example, reagent standards optionally have varying concentrations and/or varying compositions of desired materials. The materials optionally are associated with particular materials under manufacturing.

Various embodiments of the invention are configured and operated to provide increased efficiency in pharmaceutical manufacturing. These embodiments preferably include all or some of the following features: quick sampling of multiple manufacturing process streams, sampling of multiple standard sources, rapid LC analyses, and repeated frequent analyses of the sampled process streams and the standards. Desirably, an LC analysis portion of such embodiments utilizes UHPLC. Such an analysis portion performs a sample analysis in, for example, minutes rather than, for example, the half hour to an hour required by some prior systems.

With the above features, an apparatus can monitor manufacturing processes in close to a real-time manner and can collect data points spaced closely in time, for example, spaced by minutes or tens of minutes rather than by a half hour to an hour or more. Once a desired drug product begins to appear in a process stream, collection of the drug can commence with relatively accurate identification of the location of the drug in the stream. Similarly, the end of a product run is identified to permit accurate termination of collection. These features reduce the burden of holding the process stream in plumbing and tracking the location of the process stream as it proceeds while data analysis takes place with delay.

The apparatus 200 optionally includes a control unit that mediates its operation and supports automation of sample analyses. The control unit exchanges data and/or control signals via wired and/or wireless communications with, for example, the injection valve 210, the selection valve 220, and/or the pump 230.

The control unit, in various alternative embodiments, includes software, firmware, and/or hardware (e.g., such as an application-specific integrated circuit), and includes, if desired, a user interface. The control unit is optionally configured to implement the above-described sampling and monitoring processes described above.

Program code (or software) of the present invention is optionally embodied as computer-executable instructions on or in one or more articles of manufacture, or in or on computer-readable medium or media. Hence, the control unit, such as a computer, computing system or computer system, as used herein, is any programmable machine or device that inputs instructions and data, processes, and outputs, commands, or data. In general, any standard or proprietary, programming or interpretive language can be used to produce the computer-executable instructions. Examples of such languages include C, C++, Pascal, LAVA, BASIC, Visual Basic, and Visual C++.

Examples of articles of manufacture and computer-readable media in which the computer-executable instructions may be embodied include, but are not limited to, a floppy disk, a hard-disk drive, a CD-ROM, a DVD-ROM, a flash-memory card, a USB flash drive, a non-volatile RAM (NVRAM or NOVRAM), a flash PROM, an EEPROM, an EPROM, a PROM, a RAM, a ROM, a magnetic tape, or any combination thereof. The computer-executable instructions may be software as, e.g., source code, object code, interpretive code, executable code, or combinations thereof. Further, methods in accordance with at least some embodiments of the invention may be implemented in hardware (digital or analog), software, or a combination thereof.

In view of the description provided herein, one having ordinary skill in the chromatographic arts will recognize that various embodiments of the invention are not limited to specific features described above. Variations, modifications, and other implementations of what is described herein will occur to those of ordinary skill in the art without departing from the scope of the invention as claimed. Accordingly, the invention is to be defined not by the preceding illustrative description but instead by the following claims.

What is claimed is:

1. A method of liquid chromatography, comprising:
providing an injection valve comprising a sample loop;
drawing a sample from a sample source;
drawing a diluent from a diluent source;
mixing, substantially while drawing, the sample and the diluent;
pushing the mixed sample and diluent onto the sample loop; and
injecting the mixed sample and diluent from the sample loop into a solvent stream for delivery to a separation column.

2. The method of claim 1, further comprising drawing the mixed sample and diluent through the injection valve prior to pushing the mixed sample and diluent onto the sample loop.

3. The method of claim 1, wherein drawing the sample comprises drawing the sample with a syringe, and drawing the diluent comprises drawing the diluent with the syringe.

4. The method of claim 3, wherein pushing comprises pushing with the syringe.

5. The method of claim 1, wherein drawing the sample and the diluent comprise alternately drawing portions of the sample and portions of the diluent, and mixing comprises delivering the alternately drawn portions to a tube that is in fluid communication with the injection valve.

6. The method of claim 1, wherein drawing the sample comprises drawing a predetermined amount of the sample and drawing the diluent comprises drawing a predetermined amount of the diluent, to provide a selected dilution ratio.

7. The method of claim 1, further comprising drawing a reagent from a reagent source, wherein mixing further comprises mixing, substantially while drawing, the sample, the diluent and the reagent.

8. The method of claim 1, wherein the diluent comprises a standard.

9. An analytical apparatus, comprising:
a proportioning unit having a first inlet port, in fluidic communication with a sample source, a second inlet port, in fluidic communication with a diluent source, and an outlet port;
an injection valve comprising a sample loop, and having a draw state and a load state, and having an inlet port in fluidic communication with the outlet port of the proportioning unit; and
a sample pump in fluidic communication with the outlet port of the proportioning unit, if the injection valve is in the draw state, to draw both a sample from the sample source and a diluent from the diluent source through the proportioning unit and the injection valve, and in fluidic communication with the sample loop, if the injection valve is in the load state, to push the drawn sample and diluent onto the sample loop.

10. The apparatus of claim 9, wherein the proportioning unit comprises a proportioning valve.

11. The apparatus of claim 9, wherein the sample pump consists of a single syringe.

12. The apparatus of claim 9, wherein the proportioning unit further comprises a third inlet port, in fluidic communication with a reagent source or a standard source.

13. The apparatus of claim 9, wherein the sample source comprises means for selecting an on-line sample or an at-line sample.

14. The apparatus of claim 13, further comprising means for controlling the injection valve, the selection valve and the sample pump.
